(19) United States
(12) Patent Application Publication
(10) Pub. No.: US 2009/0206980 A1
(43) Pub. Date: Aug. 20, 2009

(54) THERMISTOR AND MANUFACTURING METHOD THEREOF

(75) Inventor: Masaaki Yamashita, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/368,567

(22) Filed: Feb. 10, 2009

(30) Foreign Application Priority Data
Feb. 14, 2008 (JP) P2008-033528

(51) Int. Cl. H01C 7/02

(52) U.S. Cl. 338/22 R; 29/612

(57) ABSTRACT

Provided is a thermistor that exhibits small changes in resistance before and after tripping. In a preferred embodiment, the thermistor comprises a pair of electrodes, and a thermistor layer disposed between the pair of electrodes. The thermistor layer is a cured layer of a thermistor composition that comprises a resin, conductive particles, and a cross-linking agent comprising an isocyanurate having allyl groups and glycidyl groups.

### BACKGROUND OF THE INVENTION

1. Field of the Invention

The present invention relates to a thermistor and to a manufacturing method thereof.

2. Related Background Art

Positive temperature coefficient (PTC) thermistors, whose resistance increases with increasing temperature, are used as temperature sensors or as overcurrent protection elements. Known such PTC thermistors include organic PTC thermistors that use a material in which a conductive filler is dispersed in a matrix comprising a polymer compound (polymer matrix). The polymer matrix in these organic PTC thermistors expands as the temperature rises, as a result of which the conductive paths created by the conductive filler are cut off, causing resistance to increase.

With a view to stabilizing thermistor operation, the structure of the polymer matrix of organic PTC thermistors has been conventionally strengthened by forming cross-linked structures through addition of a cross-linking agent to the polymer matrix. For instance, National Publication of Translated Version No. 2001-511598 discloses a conductive polymer composition, exhibiting PTC behavior, comprising triallyl isocyanurate as a cross-linking promoter.

### SUMMARY OF THE INVENTION

Organic PTC thermistors have come to be increasingly used in environments subjected to ever greater temperature changes, for instance in in-car applications. In these applications, however, there exist considerable temperature differences between normal regimes and high temperature regimes. When using a conventional organic PTC thermistor such as the one described above, therefore, it has been difficult to revert the shape of the polymer matrix, once having expanded through heating, to the shape it had before heating, even if the temperature is lowered. As a result, the value of resistance at normal times changes (mainly increases) whenever there is a temperature rise and subsequent drop (this thermal history will be referred to hereinbelow as “trip”). Operating conditions vary thus gradually, and as a result no stable characteristics can be obtained.

In the light of the above, it is an object of the present invention to provide a thermistor that exhibits small changes in resistance before and after tripping. Another object of the present invention is to provide a method for manufacturing such a thermistor,

As a result diligent research directed at attaining the above goal, the inventors perfected the present invention upon finding that changes in thermistor resistance before and after tripping can be made smaller by using, as a cross-linking agent, an isocyanurate having a combination of functional groups of specific structure.

Specifically, the thermistor of the present invention comprises a pair of electrodes, and a thermistor layer disposed between the pair of electrodes, wherein the thermistor layer is a cured layer of a thermistor composition that comprises a resin, conductive particles, and a cross-linking agent comprising an isocyanurate having allyl groups and glycidyl groups.

The thermistor composition that forms the thermistor layer in the thermistor of the present invention has two cross-linkable functional groups, namely glycidyl groups and allyl groups, the cross-linking conditions of which are dissimilar. When the thermistor composition is cured to form the thermistor layer, a structurally stable thermistor layer forms therefore through efficient formation of cross-linked structures.

Although the reasons are not yet wholly understood, the following factors are believed to account for the above effect. Conventionally, cross-linking agents having only one type of cross-linkable functional group have ordinarily been used for generating cross-links under definite conditions. In actuality, however, some minimum energy is required to elicit a cross-linking reaction when multiple functional groups are involved. Conceivably, this underlies the difficulty of sustaining a cross-linking reaction with good efficiency under ordinary manufacturing conditions.

In the present invention, by contrast, there is used a cross-linking agent having a combination of functional groups of dissimilar cross-linking conditions, as described above. As a result, the cross-linking reaction can take place partially also at times other than during the curing reaction, for instance during manufacture of the thermistor composition. This is believed to be one of the factors contributing to the overall increase in cross-linking efficiency. Another conceivable factor stems from the fact that the melting point of the cross-linking agent having the above-mentioned allyl groups and glycidyl groups is itself highly stable, and hence little cross-linking agent is lost in the thermistor layer formation process. The effect of the present invention, however, is not necessarily limited to the above effect.

The thermistor of the present invention having the above constitution has therefore a stable structure resulting from efficiently introducing a cross-linked structure into a thermistor layer. This allows reducing deformation before and after tripping, and allows in consequence subduing changes in resistance before and after tripping.

The method for manufacturing a thermistor of the present invention is a method for manufacturing a thermistor comprising a pair of electrodes, and a thermistor layer disposed between the pair of electrodes, the method comprising the steps of kneading a thermistor composition comprising a resin, conductive particles, and a cross-linking agent comprising an isocyanurate having allyl groups and glycidyl groups; forming a thermistor precursor layer by molding the thermistor composition after kneading; and forming a thermistor layer through a cross-linking reaction in the thermistor precursor layer, to form thereby the thermistor layer.

Such a manufacturing method allows manufacturing the thermistor of the present invention in a simple manner. The thermistor composition is manufactured by kneading. Appropriately setting the conditions during kneading allows the cross-linking reaction to take place also during the kneading step, on account of the glycidyl groups. This allows forming a cross-linked structure in the thermistor layer more efficiently.

The present invention succeeds thus in providing a thermistor that exhibits small changes in resistance before and after tripping, as well as a method for manufacturing the thermistor.

### BRIEF DESCRIPTION OF THE DRAWINGS

FIG. 1 is a diagram illustrating schematically the cross-sectional constitution of a thermistor according to a preferred embodiment.

### DESCRIPTION OF THE PREFERRED EMBODIMENTS

Preferred embodiments of the present invention are explained next with reference to accompanying drawings.

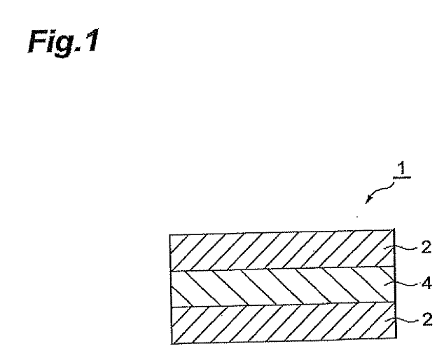

FIG. 1 is a diagram illustrating schematically the cross-sectional constitution of a thermistor according to a preferred embodiment. As illustrated in FIG. 1, a thermistor 1 comprises a thermistor layer 4 sandwiched between a pair of electrodes 2.

The pair of electrodes 2 in the thermistor 1 is formed of a conductive material that can function as a thermistor electrode. Examples of the conductive material include, for instance, metals such as nickel, silver, gold, copper, aluminum, and alloys of the foregoing. In terms of reducing the resistance and the cost of the electrodes 1, the conductive material is preferably Ni. The electrodes 2 are preferably made up of a metal foil comprising such metals or alloys. The thickness of the metal foil ranges preferably from 1 to 100 μm, in terms of weight saving, more preferably from 1 to 50 μm.

The thermistor layer 4 comprises a cured layer of a thermistor composition comprising a resin, conductive particles, and a cross-linking agent that comprises an isocyanurate having allyl groups and glycidyl groups. The resin used in the thermistor composition may be a known resin used as a matrix resin in organic PTC thermistors, for instance a thermosetting resin or a thermoplastic resin that can expand when heated. Examples of thermoplastic resins include, for instance, polyolefins (such as polyethylene), copolymers of one, two or more olefins (such as ethylene, propylene) with one, two or more olefinically unsaturated monomers having polar groups (for instance, ethylene-vinyl acrylate copolymers); polyvinyl halogenides or polyvinylidene halogenides (for instance, polyvinyl chloride, polyvinylidene chloride, polyvinyl fluoride, polyvinylidene fluoride); polyamides (for instance, 12-nylon); polystyrene, polyacrylonitrile, thermoplastic elastomers, polyethylene oxide, polyacetals, thermoplastic modified cellulose, polysulfones, poly methyl(meth)acrylate and the like.

Examples of thermosetting resins include, for instance, thermosetting resins having cross-linkable functional groups, such as epoxy resins, phenolic resins, unsaturated polyester resins, urea resins, melamine resins, furan resins, polyurethane resins and the like. The thermosetting resin may be one of the above resins further containing a curing agent, as the case may require. Since thermoplastic resins allow bringing out good PTC characteristics, the resin used in the thermistor composition is preferably a thermoplastic resin, more preferably a polyolefin, and in particular polyethylene.

The conductive particles are not particularly limited so long as they comprise a conductive material having electroconductivity.

The conductive particles comprise, for instance, carbon black, graphite, a metal or a ceramic-based conductive material. Metal particles may be, for instance, particles comprising copper, aluminum, nickel, tungsten, molybdenum, silver, zinc, cobalt, or particles resulting from plating a copper powder with nickel. Examples of the ceramic-based conductive material include, for instance, TiC, WC and the like.

Among the above, metal particles are preferred, since they allow lowering room-temperature resistance while preserving a sufficiently large resistance change rate of the thermistor. Particularly preferred are nickel particles, on account of their chemical stability in terms of, for instance, not oxidizing readily. The conductive particles can be used singly or in combinations of two or more. The conductive particles may be embodied, for instance, as primary particles or as secondary particles resulting from aggregation of primary particles. The shape of the particles may optionally have spiky protrusions.

The cross-linking agent in the thermistor composition comprises an isocyanurate having allyl groups and glycidyl groups. The isocyanurate having allyl groups and glycidyl groups is a compound having an isocyanurate ring, and at least one allyl group and one glycidyl group in the molecule. The allyl groups and glycidyl groups may be directly bonded to the isocyanurate ring, or may be comprised in a structure bonded to the isocyanurate ring.

The cross-linking agent is preferably an isocyanurate in which the allyl groups and glycidyl groups are directly bonded to respective positions on the isocyanurate ring. In this case, the allyl groups and glycidyl groups may be bonded to respective nitrogen atoms of the isocyanurate ring.

Preferably, the cross-linking agent is an isocyanurate having a structure in which glycidyl groups are bonded to one or two nitrogen atoms of the three nitrogen atoms of the isocyanurate ring, and allyl groups are bonded to the remaining nitrogen atoms. Such an isocyanurate is represented by chemical formulas (1) or (2) below. In chemical formulas (1) and (2) below, the six-member structure resulting from alternately bonding nitrogen atoms and carbonyl bonds correspond to the “isocyanurate ring”.

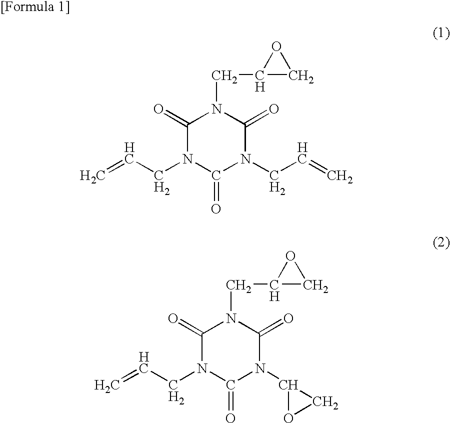

A good cross-linked structure is achieved more readily, during formation of the thermistor layer, when the isocyanurate has thus a structure in which glycidyl groups are bonded to one or two nitrogen atoms of the three nitrogen atoms of the isocyanurate ring, and allyl groups are bonded to the remaining nitrogen atoms. For instance, a good cross-linked structure fails to be formed when allyl groups are bonded to all the nitrogen atoms. Together with other factors, this results in greater resistance changes before and after tripping, during formation of the thermistor layer. When glycidyl groups are bonded to all the nitrogen atoms, the cross-linked structure forms excessively at an early stage, which tends to make the thermistor layer harder to form.

Besides the above-described components, the thermistor composition may further comprise other components, with a view to enhancing the characteristics of the thermistor layer 4. For instance, the thermistor composition may further contain a low-molecule organic compound, in order to adjust the working temperature.

The thermistor layer 4 in the thermistor 1 is a cured layer of the above-described thermistor composition. Such a cured layer has mainly a matrix structure, comprising multiple cross-linked structures created by way of the cross-linking agent in the polymer that makes up the above-described resin, with the conductive particles being dispersed in that matrix structure. The cross-linked structures are formed through bonding of structures formed by the cross-linking agent, or resulting from reactions of the cross-linking agent with itself, onto plural sites of the polymer that makes up the resin. Whether such crosslinked structures are formed or not can be checked, for instance, by dissolving the thermistor composition in an organic solvent and measuring the weight of the insoluble fraction.

A preferred method for manufacturing the thermistor 1 having the above structure will be explained next.

To manufacture the thermistor 1, the thermistor composition is formed first. The thermistor composition can be obtained by mixing predetermined amounts of the above-described resin, conductive particles and cross-linking agent. Preferably, the mixture (thermistor composition) resulting from mixing the above constituents is kneaded (kneading step) for a definite time. Kneading can be carried out in a known way using a mill, a pressure kneader, a biaxial extruder or the like.

As regards kneading conditions, the kneading temperature ranges preferably from 150 to 250° C., more preferably from 170 to 250° C., yet more preferably from 200 to 250° C., and even yet more preferably from 210 to 230° C. The kneading time is preferably no less than 10 minutes, more preferably from 15 to 40 minutes. By carrying out kneading so as to satisfy the above conditions, a cross-linking reaction can take place partially during the kneading step on account of the glycidyl groups of the cross-linking agent. This allows increasing as a result the cross-linking efficiency in the obtained thermistor layer 4.

The thermistor composition after kneading is molded next, for instance, into a sheet shape in such a way so as to obtain the desired shape of the thermistor layer 4, and form thereby a thermistor precursor layer (molding step). The obtained thermistor precursor layer is sandwiched next between, for instance, a pair of conductive sheets for forming the electrodes 2, after which a laminate is obtained, using a hot press or the like, in which the thermistor precursor layer is sandwiched between the electrodes 2.

Thereafter, the thermistor layer 4, which is a cured layer of the thermistor composition, is formed between the pair of electrodes 2 by bringing about a cross-linking reaction (curing reaction) in the thermistor precursor layer of the laminate (cross-linking step). The thermistor 1 having the above-described constitution is obtained as a result. The cross-linking reaction is preferably conducted under such conditions as allow the cross-linking reaction by the allyl groups in the cross-linking agent to take place efficiently. The cross-linking reaction can be brought about, for instance, by heat or by irradiation of active rays, as a result of which cross-links can be formed efficiently. Therefore, the cross-linking reaction is preferably brought about by electron beam irradiation. In this cross-linking reaction, cross-links may also be formed by glycidyl groups that did not react during the above-described kneading.

Although the above manufacturing method is a preferred method for manufacturing the thermistor 1, the manufacturing method can be modified arbitrarily. For instance, the cross-linking reaction may take place before sandwiching the thermistor precursor layer between the conductive sheets that yield the electrodes 2. Also, the thermistor precursor layer may be molded by pouring the thermistor composition between conductive sheets, and not by molding the thermistor composition beforehand into a sheet shape. In the above example, the cross-linking reaction is brought about after formation of the thermistor precursor layer, but the cross-linking reaction is not limited thereto, and may take place during molding of the thermistor composition. In the latter case, the molding step and the cross-linking step are carried out simultaneously.

### EXAMPLES

The present invention is explained in more detail next based on examples. However, the invention is in no way meant to be limited to or by these examples.

Thermistor Manufacture

### Example 1

Firstly, filament-like Ni particles (Ni #255, by Inco), as the conductive particles, were added and mixed, through dry blending, with a polyvinylidene fluoride resin (KF polymer, by Kureha), as the resin, to an amount of conductive particles of 35 vol % in the polyvinylidene fluoride resin. To the resulting mixture there was added, as a crosslinking agent, diallyl monoglycidyl isocyanurate (compound represented by formula (1), DA-MGIC, by Shikoku Chemicals) in an amount of 3 wt % relative to the polyvinylidene fluoride resin. The mixture was kneaded for 30 minutes in a Laboplast mill (by Toyo Seiki Seisaku-sho) while being heated at 220° C., to yield a thermistor composition in which the Ni particles were dispersed in the polyvinylidene resin.

The thermistor composition after kneading was molded to a sheet shape, having a thickness of 0.8 mm, through hot pressing at 200° C., to yield a thermistor precursor layer. The obtained thermistor precursor layer was sandwiched between two sheets of Ni foil (thickness 0.4 mm) having each one roughened face (rough face on the side of the thermistor precursor layer). The entire sandwich was heated and pressed by hot pressing to yield a laminate in which the Ni foils were fixed, as electrodes, to the thermistor precursor layer. The laminate was cut out, to a size of 9.0×3.6 mm, and was then irradiated with 100 KGy electron beams to bring about a cross-linking reaction in the thermistor precursor layer, and yield thereby a thermistor having a structure in which a thermistor layer was sandwiched between a pair of electrodes.

### Examples 2 to 4

Thermistors of Examples 2 to 4 were obtained in the same way as in Example 1, but modifying the amount of diallyl monoglycidyl isocyanurate, as the cross-linking agent, to 5 wt % (Example 2), 7 wt % (Example 3) and 10 wt % (Example 4) relative to the polyvinylidene fluoride resin.

### Comparative Example 1

The thermistor of the Comparative example 1 was obtained in the same way as in Example 1, but without adding a cross-linking agent.

### Comparative Examples 2 to 5

Thermistors of Comparative examples 2 to 5 were obtained in the same way as in Example 1, but using triallyl isocyanurate (compound in which allyl groups are bonded to all three nitrogen atoms in the isocyanurate ring) as the cross-linking agent, in an amount of 3 wt % (Comparative example 2), 5 wt % (Comparative example 3), 7 wt % (Comparative example 4) and 10 wt % (Comparative example 5).

Evaluation of Characteristics

The thermistors obtained in Examples 1 to 4 and Comparative examples 1 to 5 underwent measurement of initial resistance (resistance value immediately after thermistor manufacture) and resistance after repeated operation (resistance value after 10 repeated operations), using a Digital Multimeter by Agilent. In the latter case, the thermistors were operated under a current flow of 20 A at a voltage of 12 V in each operation. The obtained results are given in Table 1.

TABLE 1

Resistance value (mΩ)

| | Initial | Resistance after |
|---|---|---|
| | resistance | repeated operation |
| Example 1 | 1 | 6 |
| Example 2 | 1 | 4 |
| Example 3 | 1 | 4 |
| Example 4 | 1 | 8 |
| Comp. example 1 | 1 | 25 |
| Comp. example 2 | 1 | 20 |
| Comp. example 3 | 1 | 13 |
| Comp. example 4 | 1 | 17 |
| Comp. example 5 | 1 | 34 |

As Table 1 shows, the thermistors of Examples 1 to 4, which used thermistor compositions comprising diallyl monoglycidyl isocyanurate as the cross-linking agent, exhibited a very low resistance after repeated operation, relative to initial resistance, and exhibited a stable resistance value before and after tripping, as compared with the thermistor of Comparative example 1, comprising no cross-linking agent, and with the thermistors of Comparative examples 2 to 5, in which the thermistor composition used had only allyl groups as substituents of the isocyanurate ring.

What is claimed is:

1. A thermistor, comprising:
a pair of electrodes; and
a thermistor layer disposed between the pair of electrodes,
wherein said thermistor layer is a cured layer of a thermistor composition that comprises a resin, conductive particles, and a cross-linking agent comprising an isocyanurate having allyl groups and glycidyl groups.

2. A method for manufacturing a thermistor comprising a pair of electrodes, and a thermistor layer disposed between the pair of electrodes, the method comprising the steps of:
kneading a thermistor composition comprising a resin, conductive particles, and a cross-linking agent comprising an isocyanurate having allyl groups and glycidyl groups;
forming a thermistor precursor layer by molding said thermistor composition after kneading; and
forming a thermistor layer through a cross-linking reaction in said thermistor precursor layer,
to form thereby said thermistor layer.
